(19) United States
(12) Patent Application Publication
(10) Pub. No.: US 2013/0021801 A1
(43) Pub. Date: Jan. 24, 2013

(54) HELMET LIGHT DEVICE

(71) Applicant: Wen-Sung LEE, Taichung City (TW)

(72) Inventor: Wen-Sung LEE, Taichung City (TW)

(21) Appl. No.: 13/184,581

(22) Filed: Jul. 18, 2011

(51) Int. Cl. F21V 14/02; F21V 14/06

(52) U.S. Cl. 362/277; 362/372

(57) ABSTRACT

A helmet light device includes a body, a driver, an adjustable shot device and a sensor device. An illuminant is set up in the body. The adjustable shot device is moved back and forth by the driver and the adjustable shot device is moving back and forth simultaneously relative to the illuminant for adjusting the emission characteristics. The sensor device includes an electrical sensor and a battery, wherein the electrical sensor is set up on the body for receiving a command from a user to the driver and the battery provides electricity for the electrical sensor and the driver to electrically adjust the emission characteristics of the helmet light device.

### BACKGROUND OF THE INVENTION

1. Field of the Invention

The present invention relates to a helmet light, more particularly to a helmet light device for adjusting the emission characteristics conveniently.

2. Description of Related Art

When working in dark construction zones, mine, or forest, workers find it necessary to use a light to see what they are doing. The helmet light frees their hands to continue working rather than being required to hold the flashlight. The simplest helmet light is a flashlight mounted on a helmet. However, this simple design can only provide an illumination within a certain range because the lens of the flashlight is immovable. If a worker wants to increase the illuminative range or a miner wants to spotlight the mines, the simplest design cannot achieve these requirements. In order to achieve these requirements, a conventional illumination module is designed for adjusting the emission characteristics. When the worker or the miner wants to adjust the emission characteristics for increasing the illuminative range or spotlighting the mines, they can rotate a case of the illumination module to move the case back and forth relative to the illumination module. Therefore, the lens of the illumination module is moving backward or forward to increase the illuminative range or to spotlight the mines. Unfortunately, there are still two disadvantages in the conventional illumination module:

First, when the worker or the miner uses their hands to rotate the case for adjusting the emission characteristics, they might contaminate the aperture or the lens of the illumination module simultaneously because of their muddy hands or their muddy gloves. As a result, the illumination might be worse.

Second, a mechanical switch in the conventional illumination module is hard to operate for the worker or the miner in a dark circumstance.

The present invention has arisen to mitigate and/or obviate the disadvantages of the conventional.

### SUMMARY OF THE INVENTION

The main objective of the present invention is to provide an improved helmet light device for adjusting the emission characteristics conveniently.

To achieve the objective, a helmet light device comprises a body, an illuminant being set up in the body, a driver being pivoted in the body, an adjustable shot device adjustably connected to the driver, wherein the adjustable shot device is moved back and forth by the driver and the adjustable shot device is moving back and forth simultaneously relative to the illuminant for adjusting the emission characteristics, a sensor device including an electrical sensor and a battery, wherein the electrical sensor is set up on the body for receiving a command from a user to the driver such that the adjustable shot device is moved back and forth by the driver, and the battery provides electricity for the electrical sensor and the driver to electrically adjust the emission characteristics, the body having a connecting portion therein, the driver including a driving member and a control ring, the driving member being set up in the body, the control ring being pivoted on the connecting portion, a plurality of annular teeth deposited on the driving member and the control ring respectively, the driving member engaged with the control ring through the annular teeth, an aperture corresponding to the connecting portion opened on the body, the adjustable shot device being set up into the aperture, the driving member being a miniature motor, the adjustable shot device including a telescoping tube and a convex lens, the convex lens being placed into the telescoping tube, the telescoping tube having a protrusion at one end for adjustably connecting to the driver, a track spirally defined on an inner surface of the control ring for receiving the protrusion, wherein the protrusion is dragged by the track and the protrusion is moving along the track when the control ring is rotated by the driving member, thereby the adjustable shot device is moving back and forth relative to the control ring for adjusting the emission characteristics, the sensor device having an infrared sensor rather than the electrical sensor, in which the sensitivity of the infrared sensor is around 10 centimeters such that the infrared sensor is used to detect the waving hand of the user within 10 centimeters for operating the helmet light device, the sensor device having a big mechanical button rather than the electrical sensor or the infrared sensor.

Further benefits and advantages of the present invention will become apparent after a careful reading of the detailed description with appropriate reference to the accompanying drawings.

### BRIEF DESCRIPTION OF THE DRAWINGS

FIG. 1 is an exploded view of a helmet light device in accordance with the present invention;

FIG. 2 is an assembled view of the helmet light device in accordance with the present invention;

FIG. 3 is a cross-sectional view of the helmet light device along a line AA shown in FIG. 2 for showing an adjustable shot device moving back to increase an illuminative range.

FIG. 4 is a cross-sectional view of the helmet light device along a line AA shown in FIG. 2 for showing an adjustable shot device moving forth to spotlight.

FIG. 5 is a cross-sectional view of the helmet light device along a line BB shown in FIG. 2 for showing an adjustable shot device moving back to increase an illuminative range.

FIG. 6 is a cross-sectional view of the helmet light device along a line BB shown in FIG. 2 for showing an adjustable shot device moving forth to spotlight.

FIG. 7 is an assembled view of a second embodiment of the helmet light device for showing the operation; and

FIG. 8 is an assembled view of a third embodiment of the helmet light device for showing the operation.

### DETAILED DESCRIPTION OF THE INVENTION

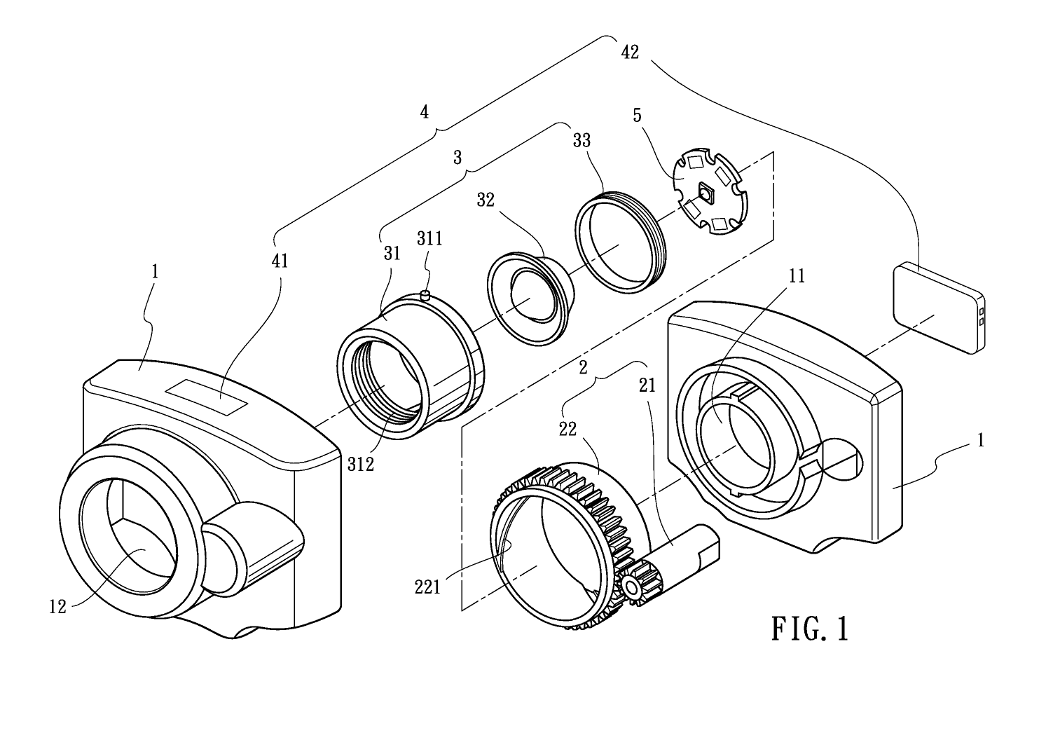

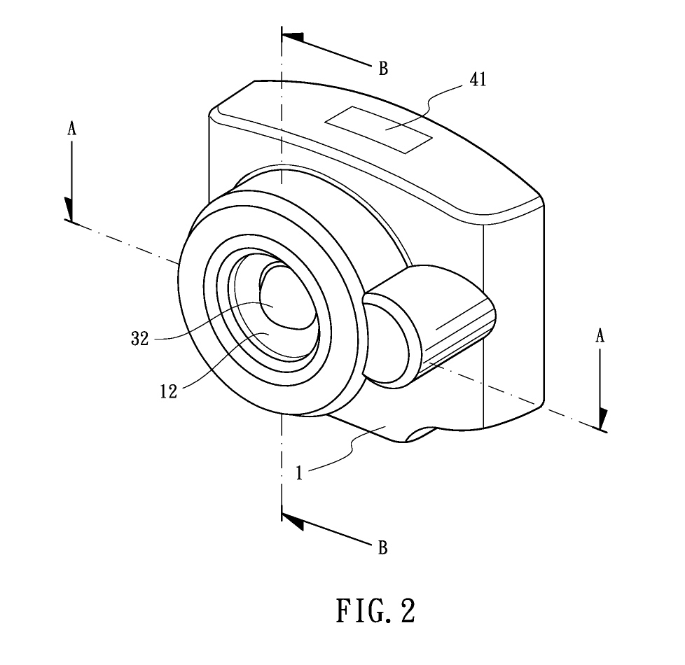

Referring to the drawings to FIGS. 1-2, a helmet light device comprises a body 1, a driver 2, an adjustable shot device 3 and a sensor device 4. The body 1 is divided into a front portion and a rear portion as shown in FIG. 1. The body 1 has a connecting portion 11 in the rear portion thereon. An illuminant 5 is set up in the body 1. A driver 2 is pivoted on the connecting portion 11. The driver 2 includes a driving member 21 and a control ring 22. The driving member 21 is set up in the rear portion of the body 1. The control ring 22 is pivoted on the connecting portion 11. A plurality of annular teeth is deposited on the driving member 21 and the control ring 22 respectively. The driving member 21 is engaged with the control ring 22 through the annular teeth. The driving member 21 is a miniature motor. An aperture 12 corresponding to the connecting portion 11 is opened on the front portion of the body 1. An adjustable shot device 3 is set up into the aperture 12. The adjustable shot device 3 includes a telescoping tube 31, a convex lens 32 and a fixing ring 33. The convex lens 32 is placed into the telescoping tube 31. The telescoping tube 31 has a protrusion 311 at one end for adjustably connecting to the driver 2. A track 221 is spirally defined on an inner surface of the control ring 22 for receiving the protrusion 311. When the control ring 22 is rotated by the driving member 21, the protrusion 311 is dragged by the track 221 and the protrusion 311 is moving along the track 221, thereby the adjustable shot device 3 is moving back and forth relative to the control ring 22. The telescoping tube 31 has an inner thread portion 312 at another end therein. The convex lens 32 is placed into the inner thread portion 312. The fixing ring 33 has a thread structure thereon for engaging with the inner thread portion 312 exactly, thereby the convex lens 32 is fixing at another end of the telescoping tube 31. The fixing ring 33 is between the convex lens 32 and the illuminant 5. When the adjustable shot device 3 is moved back and forth by the driver 2, the adjustable shot device 3 is moving back and forth simultaneously relative to the illuminant 5, thereby the convex lens 32 can move toward the illuminant 5 or move away from the illuminant 5 for adjusting the emission characteristics. The sensor device 4 includes an electrical sensor 41 and a battery 42. The electrical sensor 41 is set up on the front potion of the body 1 for receiving a command from a user and transmitting the command to the driver 2 so that the adjustable shot device 3 is moved back and forth by the driver 2. The battery 42 provides electricity for the electrical sensor 41 and the driver 2 to electrically adjust the emission characteristics of the illuminant 5.

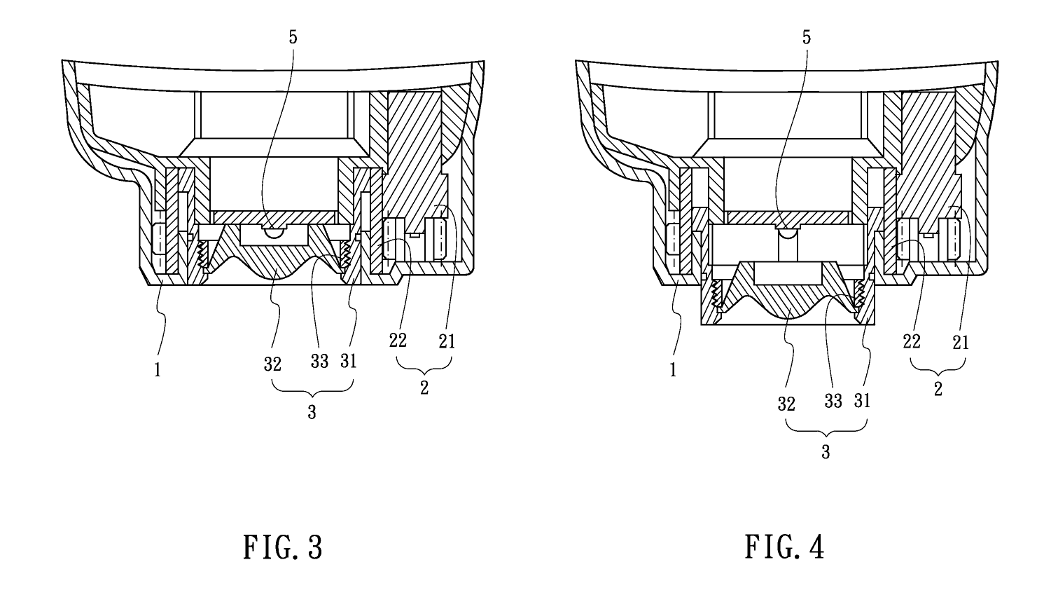

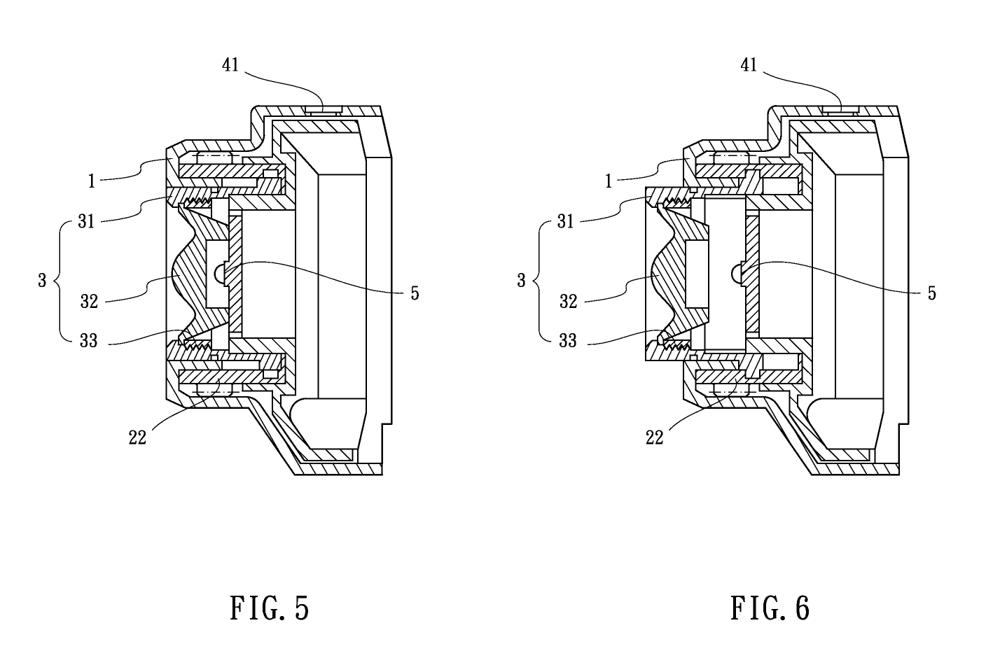

Referring to the drawings to FIGS. 3 and 5, when the sensor device 4 receives the command for moving the telescoping tube 31 back, the convex lens 32 is moved back into the body 1 so that the convex lens 32 moves toward the illuminant 5 and the light from the illuminant 5 is dispersed by the convex lens 32 to increase an illuminative range.

Referring to the drawings to FIGS. 4 and 6, when the sensor device 4 receives the command for moving the telescoping tube 31 forth, the convex lens 32 is moved forth relative to the body 1 so that the convex lens 32 moves away from the illuminant 5 and the light from the illuminant 5 is focused by the convex lens 32 to spotlight.

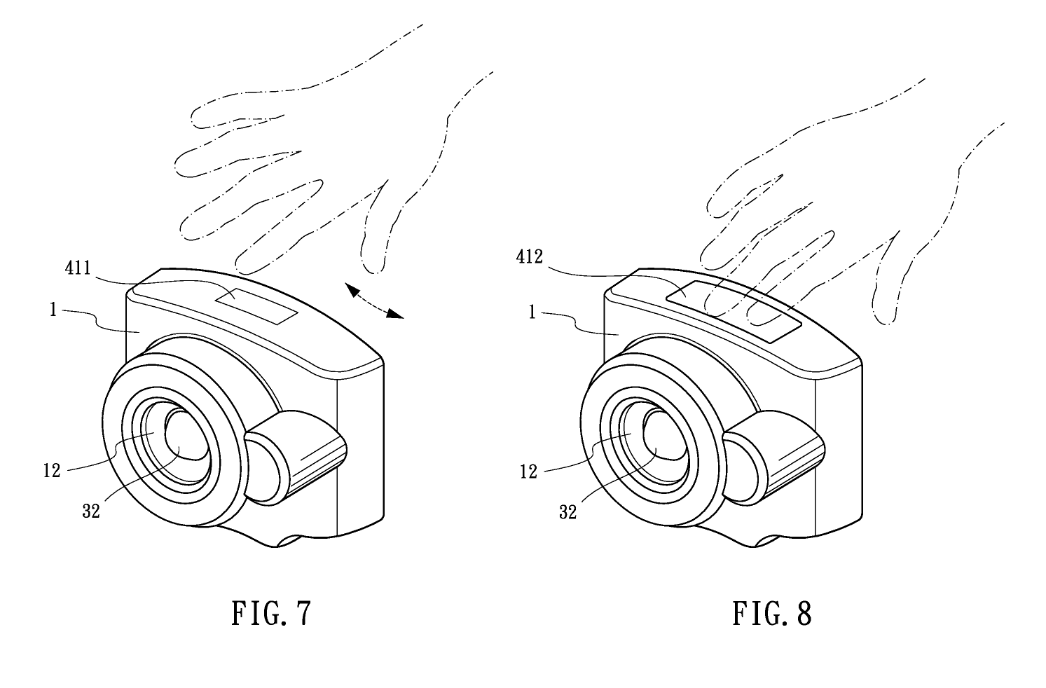

Referring to the drawings to FIG. 7, a second embodiment of the helmet light device has an infrared sensor 411 rather than the electrical sensor 41. The sensitivity of the infrared sensor 411 is around 10 centimeters. Therefore, the user does not touch the infrared sensor 411 directly in a dark circumstance to operate the helmet light device for increasing illuminative range or spotlighting, but the user only waves one hand in the sensitive range to operate the helmet light device.

Referring to the drawings to FIG. 8, a third embodiment of the helmet light device has a big mechanical button 412 rather than the electrical sensor 41. The big mechanical button 412 is enlarged in size for the conventional user to press easily in the dark circumstance. Therefore, the conventional user can directly press the big mechanical button 412 to operate the helmet light device for increasing illuminative range or spotlighting.

Although the invention has been explained in relation to its preferred embodiment, it is to be understood that many other possible modifications and variations can be made without departing from the spirit and scope of the invention as hereinafter claimed.

What is claimed is:

1. A helmet light device comprising:
a body, an illuminant being set up in the body;
a driver being pivoted in the body;
an adjustable shot device adjustably connected to the driver, wherein the adjustable shot device is moved back and forth by the driver and the adjustable shot device is moving back and forth simultaneously relative to the illuminant for adjusting the emission characteristics; and
a sensor device including an electrical sensor and a battery, wherein the electrical sensor is set up on the body for receiving a command from a user to the driver such that the adjustable shot device is moved back and forth by the driver, and the battery provides electricity for the electrical sensor and the driver to electrically adjust the emission characteristics.

2. The helmet light device as claimed in claim 1, wherein the body has a connecting portion therein, the driver including a driving member and a control ring, the driving member being set up in the body, the control ring being pivoted on the connecting portion, a plurality of annular teeth deposited on the driving member and the control ring respectively, the driving member engaged with the control ring through the annular teeth, an aperture corresponding to the connecting portion opened on the body, the adjustable shot device being set up into the aperture.

3. The helmet light device as claimed in claim 2, wherein the driving member is a miniature motor.

4. The helmet light device as claimed in claim 2, wherein the adjustable shot device includes a telescoping tube and a convex lens, the convex lens being placed into the telescoping tube, the telescoping tube having a protrusion at one end for adjustably connecting to the driver, a track spirally defined on an inner surface of the control ring for receiving the protrusion, wherein the protrusion is dragged by the track and the protrusion is moving along the track when the control ring is rotated by the driving member, thereby the adjustable shot device is moving back and forth relative to the control ring for adjusting the emission characteristics.

5. The helmet light device as claimed in claim 1, wherein the sensor device has an infrared sensor rather than the electrical sensor.

6. The helmet light device as claimed in claim 5, wherein the sensitivity of the infrared sensor is around 10 centimeters such that the infrared sensor is used to detect the waving hand of the user within 10 centimeters for operating the helmet light device.

7. The helmet light device as claimed in claim 1, wherein the sensor device has a big mechanical button rather than the electrical sensor.
